(19) United States
(12) Patent Application Publication
(10) Pub. No.: US 2025/0322175 A1
(43) Pub. Date: Oct. 16, 2025

(54) CONTENT AUTHORING TOOL WITH ARTIFICIAL INTELLIGENCE INTEGRATION

(71) Applicant: BOLD Limited, Hamilton (BM)

(72) Inventors: Katarina RICHARDS, Draper, UT (US); Mohit Kumar GOEL, Greater Noida (IN); Nimit JAIN, New Delhi (IN); Vimal KUMAR, New Delhi (IN)

(21) Appl. No.: 18/632,160

(22) Filed: Apr. 10, 2024

(51) Int. Cl. G06F 40/40; G06Q 10/1053

(52) U.S. Cl. CPC G06F 40/40; G06Q 10/1053

(57) ABSTRACT

Certain aspects of the disclosure provide methods and systems for creating résumé content. A method may include receiving a prompt text from a user interface. The prompt text provides parameters for generating the résumé content. The method may also include utilizing a selected artificial intelligence (AI) model chosen from a set of AI models configured to process the prompt text. Additionally, the method may include receiving a text-based response from the selected AI model based on the prompt. In addition, the method may include converting the text-based response to one or more résumé contents in a preset format. Further, the method may include selecting a subset of the one or more résumé content as selected résumé content. Furthermore, the method may include storing the selected résumé content in a content database for on-demand retrieval and inclusion in a résumé.

### BACKGROUND

### Field

Aspects of the present disclosure relate to content authoring, and more particularly, to content authoring tools with artificial intelligence integration.

### Description of Related Art

Job seekers are often required to create and submit résumés to employment service websites, recruiters, and potential employers. An effective strategy when preparing a résumé is to tailor the content to the job listing to which the individual is applying. For example an individual may wish to accentuate management-related tasks and skills from previous jobs when applying for a management-level position. Alternatively, the same individual may choose to focus on customer relations related skills task when submitting a résumé for a customer-facing position.

Preparing a single résumé can be a lengthy process of drafting, editing, and rewriting to arrive at a document that has an appealing layout, and concisely states an individual's qualifications in a limited space, generally a single page. However, preparing multiple résumés, each with a different focus and target employment position, can require significantly more effort. Thus, many applicants simply submit the same generalized résumé regardless of the job requirements.

A problem with a single generalized résumé comes from the prevalent use of résumé parsing software by employers. The résumé parsing software is used by employers to sort through a large number of résumés, many of which may not be suitable for the position offered, to select the few that are most relevant to the position offered. A generalized résumé may not score highly with the résumé parsing software simply because the keywords and phrases being searched for by the résumé parsing software do not appear or are not emphasized enough in the résumé.

Consequently, a need exists for systems and methods that can provide content to an individual that is tailored to specific job criteria.

### SUMMARY

Certain aspects provide a method for creating résumé content. For example, method may include receiving a prompt text submitted by an user by way of an user interface, the prompt text including at least a job title for which to generate the résumé content. The method may also include creating an updated prompt including: the prompt text, a selected artificial intelligence (AI) model chosen from a set of AI models configured to process the prompt text, AI model parameters configured to control processing of the prompt text by the selected AI model, and response formatting instructions. The method may furthermore include transmitting the updated prompt to the selected AI model. The method may in addition include receiving a text-based response from the selected AI model based on the prompt text, the text-based response being received in a format corresponding to the response formatting instructions.

Certain aspects provide a method for generating content for a résumé. For example, the method may include providing a user interface having a prompt field, a content output field, and one or more interactive elements. The method may also include receiving prompt text at the prompt field, the prompt text being a user request including a job title for which to generate a résumé content. The method, furthermore, may include generating an updated prompt including: the prompt text, an artificial intelligence (AI) model selection chosen from a set of AI models configured to process the user request, AI model parameters configured to control the processing of the user request by the AI model selection, and response formatting instructions. The method may, additionally, include receiving, at a content output field, one or more résumé contents generated by the selected AI model based on the prompt text, the one or more résumé contents being presented in a format corresponding to the response formatting instructions.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a user interface implementing aspects of the present disclosure.

FIG. 2 depicts a block representation of a process implementing aspects of the present disclosure.

FIG. 3 depicts a method implementing aspects of the present disclosure.

FIG. 4 depicts another method implementing aspects of the present disclosure.

FIG. 5 depicts a processing system capable of implementing aspects of the present disclosure.

FIG. 6 depicts an example user-entered prompt in accordance with aspects of the present disclosure.

FIG. 7 depicts an example response generated from the prompt shown in FIG. 6 in accordance with aspects of the present disclosure

FIG. 8 depicts an example prompt ready to be submitted to an AI model for processing, in accordance with aspects of the present disclosure.

FIG. 9 depicts an example log entry in accordance with aspects of the present disclosure.

It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating content using AI. For example, aspects of the present disclosure generate résumé content that can be stored and accessed by individuals using a résumé creation service to create professional quality résumés with reduced effort. As another example, aspects of the present disclosure provide content directed to, for example, specific job titles, that can then be incorporated into an example résumé, either as-is or with edits by the content author.

Aspects of the present disclosure provide techniques for integrating AI tools into a content creation workflow in order to reduce production time and cost. In particular, aspects of the present disclosure generates customized prompts for a target AI model, e.g., a large language model (LLM) or other generative AI models, that causes the AI model to generate raw content satisfying one or more criteria related to the desired output. Thus, for example, for résumé content, the prompt may provide instructions for the AI model to create a defined number of previous job descriptions directed to a particular job title, related skills matching a given experience level, and an education appropriate for the job history. Moreover, the prompt may instruct the AI model to output the content in a particular format that can be easily imported into content authoring tools. Thus, certain aspects of the present disclosure free content creators from having to create each résumé content item from scratch, instead the content creators can start from AI-generated content. In this way the content creators can focus their time on editing the generated content and enhancing the content with additional details.

Currently, content authoring, particularly authoring résumé content, can be a tedious and time-consuming endeavor in which a content author creates content, such as articles or sample résumés from scratch. In the case of résumés in particular, it can be difficult for a content author to create a large number of different sample résumés with varying content. For example, a content author may tend to use a limited number of job skills, job titles, or work history repeatedly in the résumé samples, as it can be quite difficult to constantly originate new and diverse content. Generally, most individuals will gravitate to careers, work histories and education backgrounds with which they are most familiar. Consequently, even though a content creator may generate a large number of résumés, these résumés will most likely be fairly similar to each other or at best fall into one of several limited groupings, as the individual content items (e.g., job descriptions, titles, summaries, etc.) will tend to be the same. In other words, they will lack the content diversity necessary to be useful to a wide audience. For example, a content author with a background in engineering may tend to unconsciously create résumés that are more heavily focused on engineering/technical fields. On the other hand, a content author that has experience in customer service industries may instead unconsciously develop résumés that gravitate to customer service jobs. Similarly, education level and background may influence the content of the sample résumés produced, resulting in lack of diversity across content items that focus on jobs of a particular type, or within a particular field of endeavor.

This unconscious bias can lead to content that is so similar so as to appear repetitive, resulting in content that does not appeal, or seem relevant, to entire groups of potential customers or subscribers. In other words, when done as a (human) mental process, the results are objectively and subjectively lacking in diversity of content (e.g., individual job descriptions, titles, summaries, etc.). By leveraging generative artificial intelligence (AI) to generate content that may then be used as-is, or as a starting point, for a new sample résumé and/or resume content, aspects of the present disclosure can assist in creating a diverse collection of content from which further sample résumés may be created. In this way, more diverse and comprehensive content may be created that will appeal to more and larger groups of individuals. In other words, the impact of the generative AI is to improve the process in a way that a human inherently cannot due to, for example, inherent bias.

Additionally, sample résumés and resume content that are engaging and showcase the services available through a résumé creation platform can require significant labor on the part of the content author. Thus, a content author may create only a few résumé content per hour. However, by applying aspects of the present disclosure, high quality résumé content can be created in significantly less time. In particular, content authors may no longer be burdened with originating résumé content. Instead, the content authors can focus on enhancing the résumé content produced by the AI model, and on the formatting and other visual aspects of the sample résumé.

Consequently, aspects of the present disclosure are directed to address limitations in the diversity, quantity, and quality of résumé content provided to individuals, such as content creators generating individual content items and sample résumés for marketing purposes, or end-users creating a finished résumé ready for submission to an employer. By implementing aspects of the present disclosure, content, such as job summaries, skills narratives, cover letter text, and the like may be generated more quickly, with more diverse descriptions and without inherent bias. For example, content creators, as is true with any writer, will tend to write content a certain way—the choice of wording, tone, formality, and the like—such that content written by one content creator on a particular subject versus content on the same subject by a different content creator will read differently, and appeal to different readers.

Aspects of the present disclosure, by leveraging generative AI, may be tuned to provide content that appeals to a wider audience. When the content is résumé oriented, individuals may prefer to see content that is written in a manner that is similar to their own writing style. Thus, whether providing sample résumés showcasing a résumés creation service or building block content for creating an end user's own résumés, content written in different styles will be usable by more individuals.

### Example User Interface

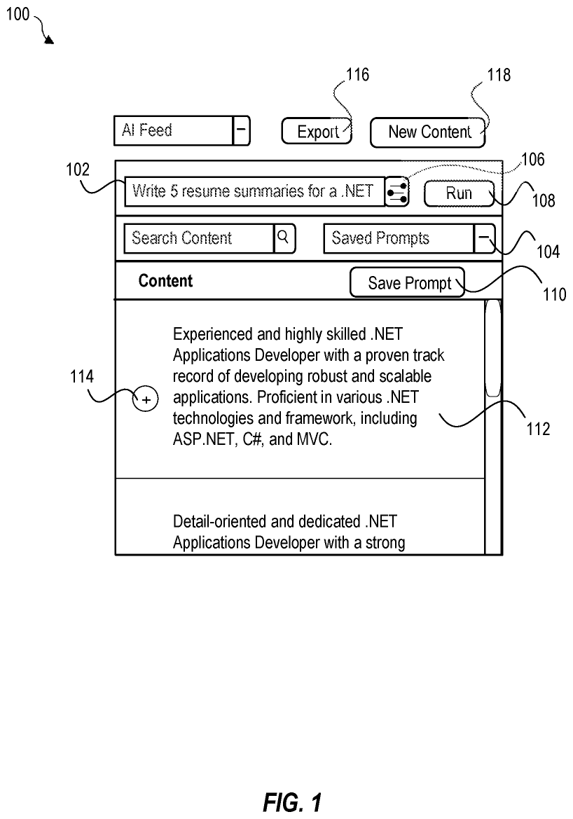

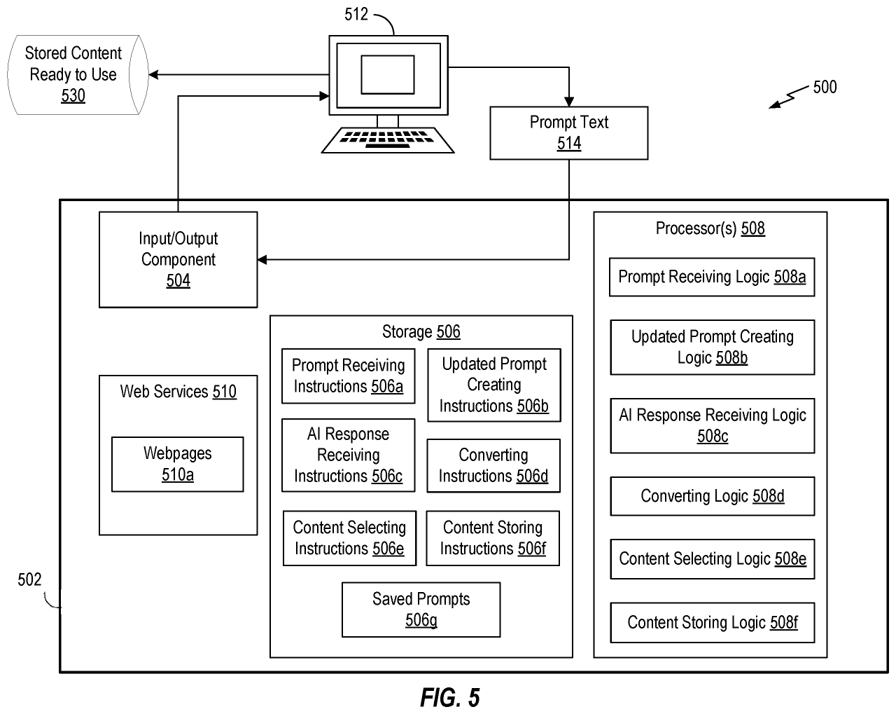

FIG. 1 depicts an example user interface (UI) 100, displayed on a workstation, such as workstation 512 shown in FIG. 5, and provided by a processing system implementing aspects of the present disclosure, such as processing system 502 shown in FIG. 5. The UI 100 shown in FIG. 1 is a graphical user interface (GUI), however in the context of the present disclosure, it is understood that the UI 100 is not limited to a GUI, but rather may be implemented in other forms, such as spoken prompts, for example, which may be advantageous for users that are visually impaired. For brevity, the present disclosure will focus on a graphical version of the UI 100. In the embodiments described herein, the UI 100 is treated as being provided by a separate processing system 502 to a workstation 512 (e.g., in a server-client arrangement), however, aspects of the present disclosure are not limited to this arrangement alone. Generally, aspects described herein may be implemented on a single processing device or across distributed processing devices. The UI 100 may, in some embodiments, be embodied in program code (e.g., a software application) that is stored on, and executed by the workstation 512. The program code provides bi-directional communication between the UI 100 and the processing system 502.

The UI 100 may include a plurality of interactive elements, such as text input fields, drop-down menus, text edit fields, buttons, and the like. In particular, UI 100, in certain embodiments, presents a prompt field 102 configured to accept a text input from a user as a user request. For example, a typical user request (also referred to herein as a prompt), in accordance with aspects of the present disclosure, may be: “provide 5 résumé summaries for a .NET developer with 5 years of experience”. Another example user request may be: “provide 3 summaries of education history for an individual with 10 years of experience in software related project management”.

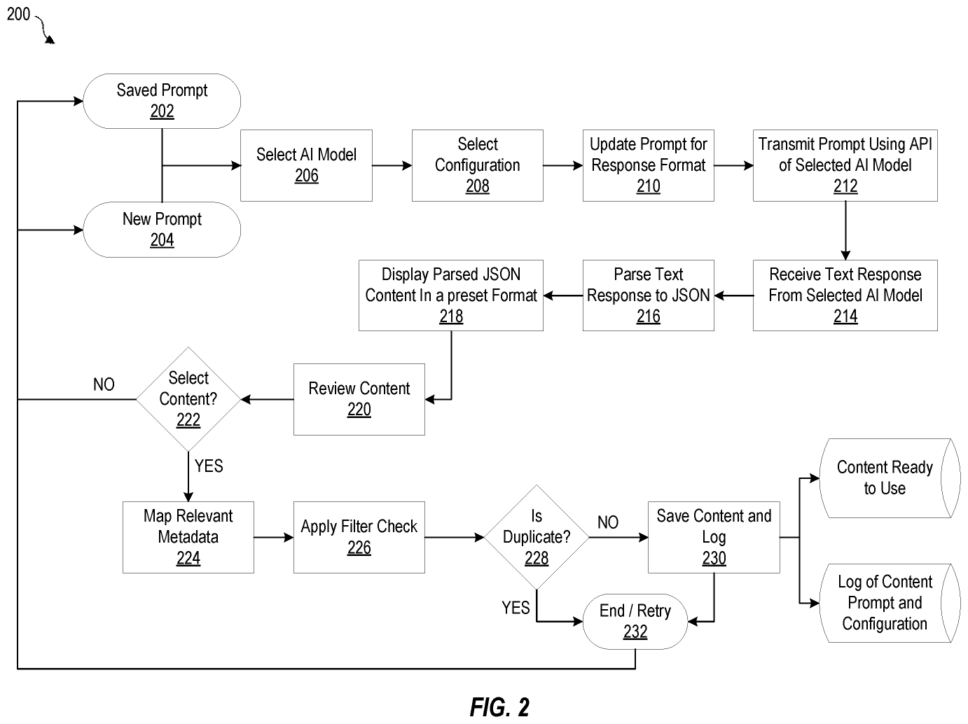

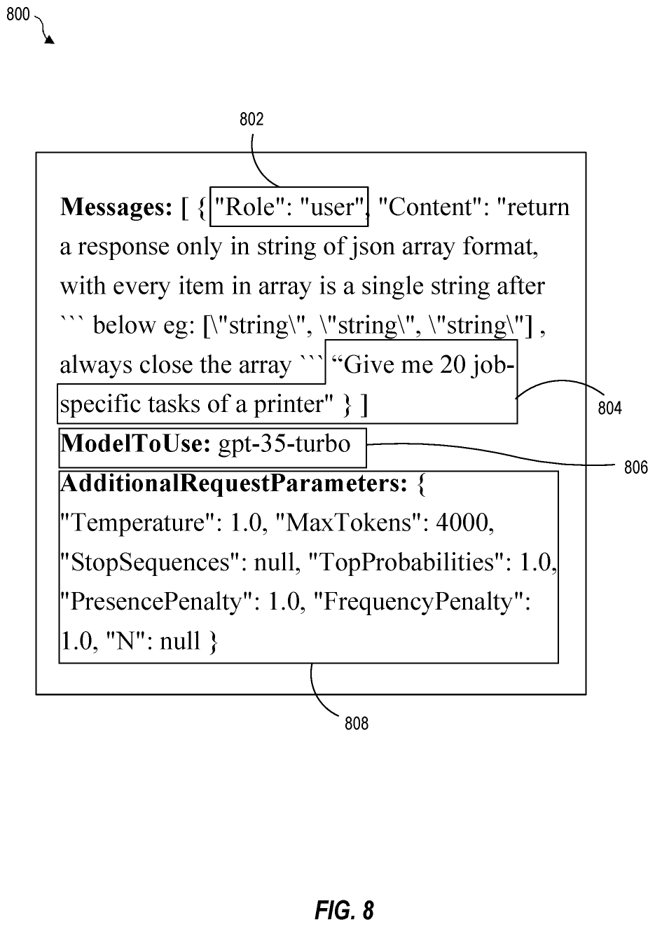

In addition, the UI 100 may include a saved prompt drop-down box 104. The saved prompt drop-down box 104 may be configured to provide the user with a list of previously saved prompts (e.g., saved prompts 506g of FIG. 5). The saved prompts may include, in certain embodiments, prompts that were previously entered by the user in the prompt field 102 and subsequently saved by actuation of a save prompt button 110. In certain embodiments, the saved prompt drop-down box 104 may include prompts saved by other users. Prompts saved by users may be stored in a database residing on the processing system 502, for example, and retrieved by the UI 100 during operation of the UI 100. In certain embodiments, selecting a saved prompt from the saved prompt drop-down box 104 causes the text corresponding to the selected saved prompt to be displayed in the prompt field 102. This allows, the user to instruct a backend server, such as the processing system 502 shown in FIG. 5, executing process 200 shown in FIG. 2 to modify elements of the saved prompt before sending an updated prompt (such as updated prompt 800 of FIG. 8) onto the AI model for processing.

Certain aspects of the present disclosure provide a settings menu 106 that, when actuated, may display a settings UI (not shown) allowing the user to set various parameters, such as engine (or AI model), maximum token (or context window), temperature, frequency penalty, presence penalty, and top-p, which may be implemented using appropriate interactive UI elements. The engine setting may allow a user to select from several different AI models. In certain embodiments, the AI model being used is fixed and not selectable by the user. In other implementations, the AI model is selected by the backend server based on defined criteria. Certain aspects provide for the various parameters to be set at the backed server rather than by the user.

Maximum token sets a limit on the number of tokens per model response. For example, some AI model APIs supports a maximum of 4000 tokens shared between the prompt (including system message, examples, message history, and user query) and the model's response. One token is roughly 4 characters for typical English text.

Temperature controls randomness, such that lowering the temperature setting causes the AI model to produce more repetitive and deterministic responses, while an increased temperature setting will result in more unexpected or creative responses.

Top-p (e.g., top probability), similar to temperature, controls randomness but uses a different method. Lowering top-p will narrow the model's token selection to likelier tokens. Increasing top-p will let the model choose from tokens with both high and low likelihood. Because of the related nature, the user may adjust temperature or top-p, but not both at the same time.

Frequency penalty allows the user to reduce the chance of repeating a token proportionally based on how often it has appeared in the text so far. This decreases the likelihood of repeating the exact same text in a response.

Presence penalty reduces the chance of repeating any token that has appeared in the text at all so far. This increases the likelihood of introducing new topics in a response.

The user can submit either a prompt manually entered into prompt field 102 or a previously saved prompt selected from the saved prompt drop-down box 104 by actuating a run button 108. Actuating the run button 108 causes the prompt shown in the prompt field 102 to be transmitted to the processing system 502 executing process 200 of FIG. 2, for example, where the text entered in the prompt field 102 and any additional settings, provided by way of the UI 100, are incorporated, along with further enhancements, into an updated prompt, such as updated prompt 800 of FIG. 8. The updated prompt is subsequently transmitted by the backend server to the selected AI model. Responses received from the AI model by the processing system 502 are presented in a text edit box, such as results field 112. As shown in FIG. 1 the prompt field 102 requests five résumé summaries, thus the results field 112 may display five summaries at one time, with a scroll bar providing the user with the ability to scroll through all the summaries. In certain embodiments, the results may be shown one at a time with forward and backward buttons allowing the user to view each result in succession.

A selector element 114, such as a checkbox or the like, is provided for each result displayed in results field 112. By actuating the selector element 114, the user can approve or reject individual results. The results field 112, may, in certain embodiments, allow editing of the individual result text by the user. An export button 116, when actuated, may cause the workstation 512 to save the approved results, including any edits, identified by the state of the selector element 114. The approved results may be saved locally in a storage unit directly coupled to the workstation 512. Alternatively, the approved results may be transmitted to, and stored in a remote database, such as storage 530 shown in FIG. 5.

A new content button 118 may be provided on the UI 100 that clears the results field 112 when actuated. Thus, when each subsequent query is made to the AI model, the user first clears the previous results by actuating the new content button 118. In certain embodiments, the functionality of the new content button 118 may be combined with the functionality of the run button 108. Thus, actuating the run button 108 causes the results field 112 to be cleared and the prompt displayed in the prompt field 102 to be transmitted to the processing system 502 for subsequent processing by the AI model.

### Example Process

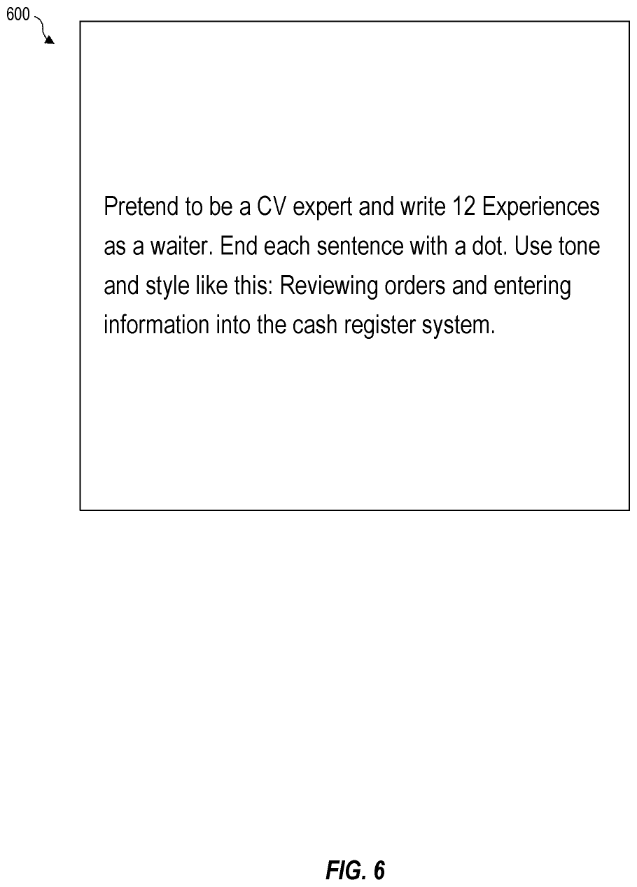

FIG. 2 depicts an example block representation of a process 200 performed by a backend processing system, such as the processing system 502 shown in FIG. 5. The process begins by receiving a prompt text, such as the user-entered prompt text 600 shown in FIG. 6, from a UI (e.g., UI 100 of FIG. 1). The prompt text may be a saved prompt at block 202 selected by the user from a drop-down box (e.g., saved prompt drop-down box 104). The saved prompts (e.g., saved prompts 506g of FIG. 5) may be stored in storage (e.g., storage 506 of FIG. 5) on the processing system 502. Alternatively, the prompt text may be a new prompt 204 manually entered by the user in a text field (e.g., prompt field 102 of FIG. 1) provided on the UI 100.

The process 200 selects an AI model at block 206. The AI model may be selected based on a selection made by the user from a list of AI models presented in a menu (e.g., settings menu 106 of FIG. 1) of the UI 100. The list of AI models may include any available generative AI models, such as large language models (LLM) and the like. Alternatively, an AI model may be selected by the processing system 502 based on the user's discretion and preference, for example, certain AI models may provide better non-English responses than other AI models. The selected AI model can be changed by the user as desired based on the quality of the responses being received from the selected AI model. The AI model setting may default to the most current available model in certain implementations of aspects of the present disclosure. The process 200 may, in certain implementations, also select configurations of the response at block 208. The user may adjust different parameters in the UI 100, for example, via settings menu 106.

Based on the AI model selected at block 206, and the configurations selected at block 208, the process 200 updates the prompt text at block 210 to include instructions reflecting the selected configuration of block 208 for the selected AI model. The updated prompt text (e.g., 800 of FIG. 8) may include instructions for outputting the response in a desired format, such as a JSON format, that can be easily imported into the systems used by the processing system 502. For example, the updated prompt may include the following instructions for placing the results in JSON format:

return a response only in string of json array format, with every item in array is a
single string after ‘‘‘ below eg: [\″string\″, \″string\″, \″string\″] , always close the
array ‘‘

FIG. 8 shows an example updated prompt text 800 that may be generated at block 210 based on the text entered by the user in the prompt field 102 of FIG. 1 in accordance with aspects of the present disclosure. As shown in FIG. 8, the prompt 800 includes a role directive 802 that, in this case, is set to “user”. However, the role can be set to a “CV expert”, “job applicant”, or the like. The role directive instructs the AI model to emulate that type of individual when generating the content. While a role does not need to be assigned to the AI model, by assigning one, the AI model may generate content that is more customized. The role directive 802, in certain aspects of the present disclosure, may be set at a backend server, such as processing system 502 of FIG. 5, and thus not adjustable by the user. Alternatively, the role directive 802 may be set by the user through a drop-down menu or the like. Additionally, the prompt 800 includes a user request 804, which describes the desired content of the output generated by the AI model, in this case “20 job-specific tasks of a printer”.

The prompt 800 may also identify the particular AI model to use for generating the content by setting a ModelToUse directive 806. As with the role directive 802, the ModelToUse directive 806 may be set at the backend server. In some implementation of aspects of the present disclosure, the backend server may include additional processes configured to select between multiple available AI models based on defined criteria, such as output language, and the like. In other implementations of certain aspects of the present disclosure, the ModelToUse directive 806 may be set by the user by way of a drop-down menu or the like provided on the user interface 100.

Additional AI parameters may be set by the backend server with the AdditionalRequestParameters field 808. Implementations of certain aspects of the present disclosure may include such model parameters as context window (e.g., max tokens), temperature, top probabilities, presence penalty, frequency penalty and the like as values for the AdditionalRequestParameters field 808. Based on the particulars of the prompt provided by the user, the AI model may generate résumés content, such as example job summaries, or example education histories. Accordingly, as shown in FIG. 8, the user request 804, e.g., “give me 20 job-specific tasks of a printer”, is further enhanced at block 210 of FIG. 2 to include additional processing instructions for the AI model, such as a role directive 802, output formatting instructions, a model selection (e.g., ModelToUse) directive 806, and additional model parameters (e.g, AdditionalRequestParameters field 808). Incorporating these additional instructions and directives improves the results generated by the AI model over what would be received based solely on the user request 804 submitted by way of prompt field 102 shown in FIG. 1.

The updated prompt text is transmitted by process 200 at block 212 to the selected AI model. In certain embodiments, the prompt text is transmitted using application programming interface (API) for the selected AI model. The AI model processes the updated prompt text and transmits the results to the processing system 502. The results, e.g., text responses, from the AI model are received by the process at block 214.

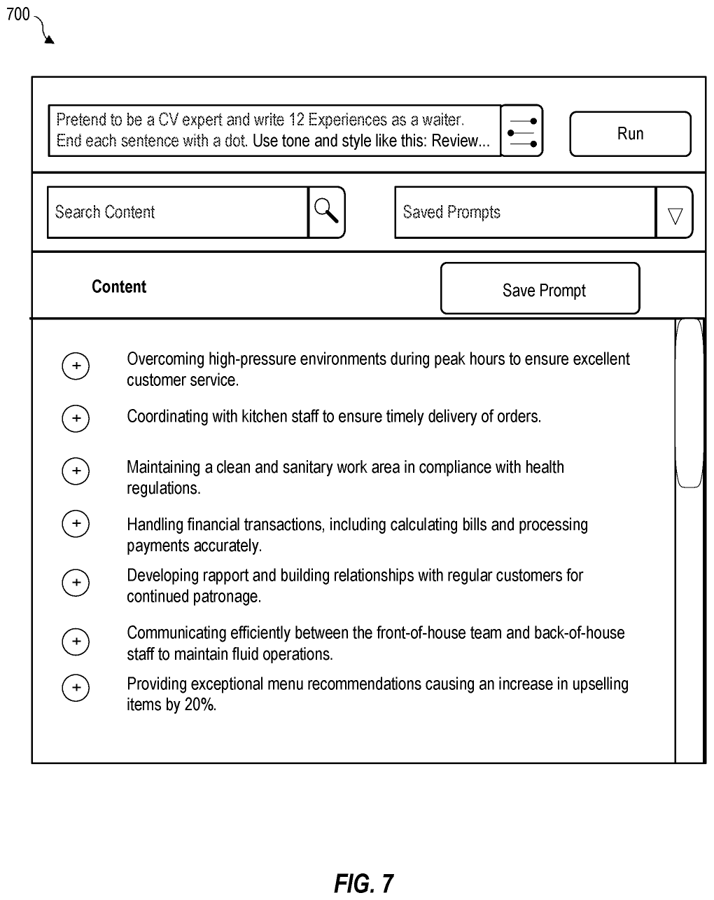

At block 216, the process 200 parses the text response received from the AI model into a JSON format. Subsequently, the process 200 displays the parsed response text (referred hereinafter as résumé content), at block 218, in a text box (e.g., results field 112 of FIG. 1) on the user interface (e.g., UI 100 of FIG. 1). FIG. 7 shows a UI 700 presenting examples of résumé content generated in response to the prompt shown in FIG. 6. The résumé content can be reviewed and, in certain implementations, edited at block 220. As shown In FIG. 1, the UI 100 includes a selector element 114 that allows a user to select one or more of the résumé content displayed in the results field 112 to be saved in a content database.

At block 222, if no resume contents are selected in the UI 100 by the user, the process 200 terminates, and waits until either another saved prompt 202 or new prompt 204 are received. On the other hand, if one or more résumé contents are selected, at block 222, the process 200 proceeds to block 224.

At block 224, the process 200 maps the text of the résumé content to relevant metadata. Initially, the text of the résumé content may be mapped to a particular job title and occupation by tagging the résumé content with the job title and occupation provided by the user in the user request. For example, the résumé content resulting from the user request “provide 5 résumé summaries for a .NET developer with 5 years of experience” may be tagged with .NET developer for both the job title and occupation. Alternatively, the occupation may be set to Computer programmer, or the like, based on a lookup table correlating .NET developer with computer programming, for example. In addition to job title and occupation, the metadata may include fields such as, for example, job hierarchy, qualifications/certification, linguistic classifications, and the like. The metadata may be used to facilitate classifying and organizing the résumé content. The mappings may be used to track data performance, as well as facilitate delivery of the content to a user of the system based on the job title/occupation being searched for in the product. The user may be able to modify and add additional metadata tags once the content has been added to the system.

At block 226, process 200 applies a filter check to verify that duplicate résumé content has not already been entered into the system.

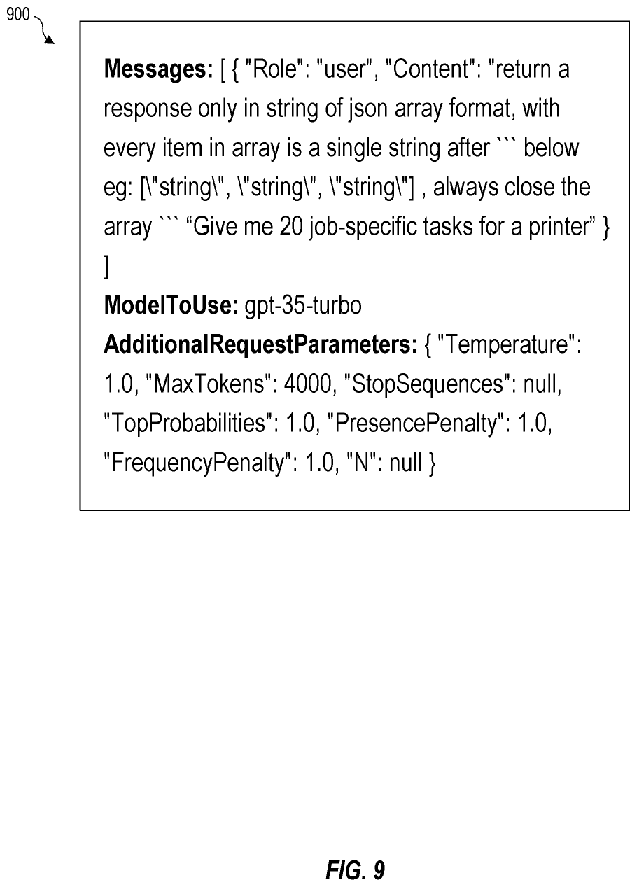

At block 228, the one or more selected résumé contents are compared to previously stored résumé contents. If all of the selected résumé contents are duplicates of the previously stored résumé contents, the process 200 proceeds to block 232 where the process ends and waits for another saved prompt 202 or new prompt 204 to be received. If one or more of the selected résumé contents are not a duplicate of previously stored résumé content, those non-duplicative selected résumé contents are saved to a content database in a storage, such as storage 530 of FIG. 5. Additionally, the process 200 submits a log entry, such as the example log entry 900 shown in FIG. 9 to a log database at block 230. The process continues to block 232.

### Example Methods

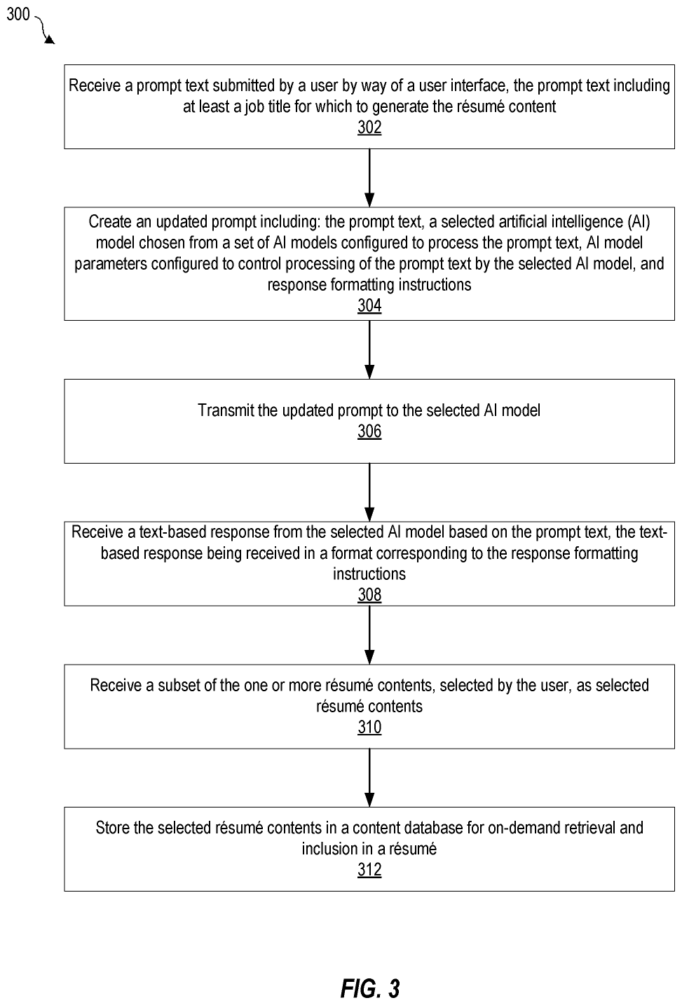

FIG. 3 depicts a method 300 for generating résumé content. The method 300 may be executed on a processing system (e.g., processing system 502 of FIG. 5) and in communication with a workstation (e.g., workstation 512 of FIG. 5).

At block 302, the method 300 receives a prompt text submitted by a user by way of a user interface, (e.g., UI 100 of FIG. 1). The prompt text includes at least a job title for which to generate the résumé content. In certain embodiments, the method 300 transmits, to the user interface, a set of stored prompts (e.g., saved prompts 506g of FIG. 5) from which the prompt text can be chosen. The prompt text received by the processing system is selected from the set of stored prompts. Additionally, in certain embodiments, the method 300 accepts a user-submitted prompt text.

At block 304, the method 300 creates an updated prompt. The updated prompt may include: prompt text, a selected artificial intelligence (AI) model chosen from a set of AI models configured to process the prompt text, AI model parameters configured to control processing of the prompt text by the selected AI model, and response formatting instructions.

At block 306, the method 300 transmits the updated prompt to the selected AI model.

At block 308, the method 300 receives a text-based response from the selected AI model based on the updated prompt text. The text-based response may be received in a format corresponding to the response formatting instructions. The method 300 maps one or more of the selected résumé contents to at least the job title by attaching metadata tags the one or more of the selected résumé contents at least the job title extracted from the prompt text. In certain embodiments the metadata mappings may also include fields such as occupation, job hierarchy, linguistic classifications, qualifications/certification, and the like. Certain fields, such as job title, may be automatically mapped by the method 300, based on the prompt text entered in the UI 100. Other fields may be mapped manually by the user.

At block 310, the method 300 receives a subset of the one or more résumé contents, selected by the user, as selected résumé contents.

At block 312, the method 300 stores the selected résumé content in a content database for on-demand retrieval and inclusion in a résumé.

As shown in FIG. 3, resume content is generated by the AI model from a brief request by a content creator, thus the AI model is allowed to generate a broad range of content within the boundaries set by the content creator's request. For example, an AI model receiving a request for “5 résumé summaries for a .NET developer with 10 years of experience” may provide 5 entirely different summaries for the request job title, without being limited, as a human content creator may be, by personal experiences and biases. Therefore, the resulting content that may be provided to the end user by aspects of the present disclosure may be more varied. Moreover, aspects of the present disclosure can provide a significantly larger quantity of content than would be possible from an individual content creator during the same period of time. As described above, the content creator provides a prompt for a certain number of summaries, for example, and proofreads, edits, or adds details to the results received from the AI model. Because the content creator is not creating each summary from scratch, content creator can be significantly more productive by finalizing summaries generated by the AI model, instead. While the example provided here requests 5 summaries, in practice, 100 summaries could be requested from the AI model with only a modest increase in time while the AI model generates the summaries. A content creator manually creating the summaries would provide only a fraction of the summaries in the same time. Thus, aspects of the present disclosure provide an increase in both quality and quantity of content being generated.

In addition to the user request, submitted by the user as a prompt text, a backend server, such as processing system 502 shown in FIG. 5, creates an updated prompt by modifying the user submitted prompt text with additional instructions. These additional instructions may include which AI model to use, instructions regarding the format of the output (e.g., output the response in JSON format), and customized settings for parameters of the selected AI model. By having the backend server modify the prompt text received from the user, the user does not need to receive extensive trained on writing AI prompts. Instead, the user need only focus on writing a request, in plain English, for example, for the desired content (e.g., “5 résumé summaries for a .NET developer with 10 years of experience”).

Note that FIG. 3 is just one example of a method, and other methods including fewer, additional, or alternative steps are possible consistent with this disclosure.

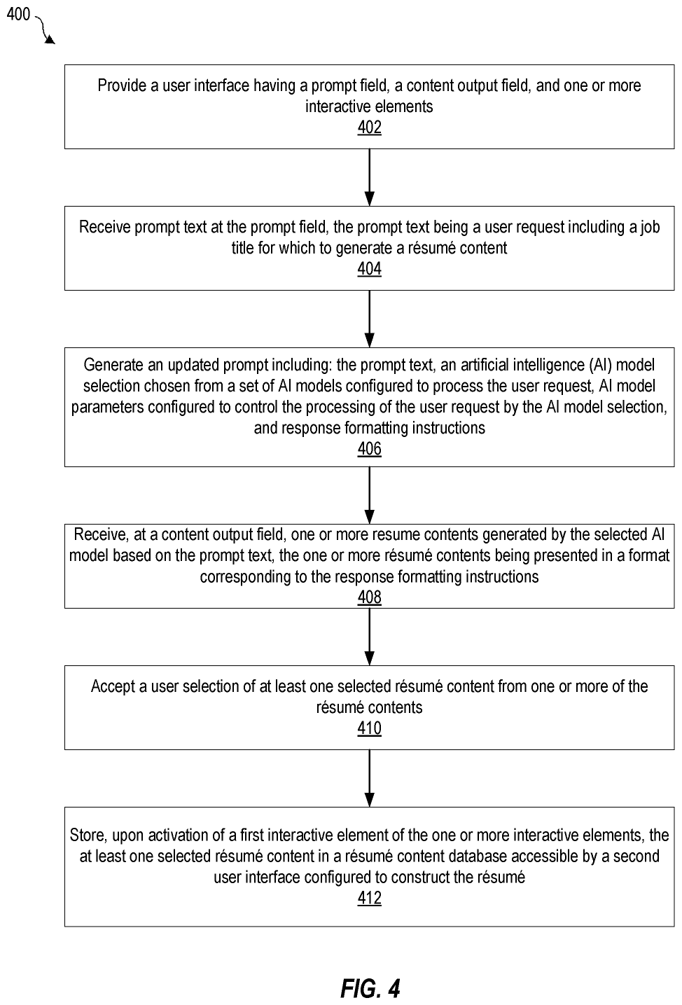

FIG. 4 depicts a method 400 for generating content for an employment-related document, such as a résumé, a curricula vitae, and the like. The method 400 may be executed on a workstation (e.g., workstation 512 of FIG. 5) and in communication with a processing system, (e.g., processing system 502 of FIG. 5).

The method 400 begins at block 402 by providing a user interface (e.g., UI 100 of FIG. 1) having a prompt field (e.g., prompt field 102 of FIG. 1), a content output field (e.g., results field 112 of FIG. 1), and one or more interactive elements.

At block 404, the method 400 receives a prompt text (e.g., user request) at the prompt field. The prompt text may including a job title for which to generate a résumé content. The prompt text may be entered in the prompt field manually by a user. In certain embodiments, the prompt text may be selected by a user from a drop-down box (e.g., saved prompt drop-down box 104 of FIG. 1) listing previously saved prompts (e.g., saved prompts 506g of FIG. 5). The text of the selected prompt may be displayed in the prompt field, affording the user an opportunity to customize the prompt text. In certain embodiments, an interactive element (e.g., save prompt button 110 of FIG. 1) is provided on the UI that, when actuated, saves the prompt text. The prompt text may, in certain embodiments, be save on a locally stored database. In other embodiments, the prompt may be saved on a remote server, such as processing system 502 of FIG. 5, network area storage (NAS), (e.g., storage 530 of FIG. 5), cloud storage, or the like.

At block 406, the method 400 generates an updated prompt (e.g., updated prompt 800 shown in FIG. 8) including: the prompt text, an artificial intelligence (AI) model selection chosen from a set of AI models configured to process the user request, AI model parameters configured to control the processing of the user request by the AI model selection, and response formatting instructions.

At block 408, the method 400 receives, at a content output field (e.g., results field 112 of FIG. 1), one or more résumé contents generated by the selected AI model based on the prompt text. The one or more résumé contents may be presented in a format corresponding to the response formatting instructions provided to the AI model in the updated prompt.

At block 410, the method 400 accept a user selection of at least one selected résumé content from one or more of the résumé contents. In certain embodiments, the user may indicate a selection of a résumé content by actuating an interactive element (e.g., selector element 114 of FIG. 1) associated with that résumé content.

At block 412, the method 400 stores, upon activation of an interactive element (export button 116 of FIG. 1) of the one or more interactive elements, the at least one selected résumé content in a résumé content database accessible by a second user interface (not shown) configured to construct the résumé. In certain embodiments, the method 400 may map the at least one selected résumé content to at least the job title by attaching to metadata of the one or more of the selected résumé contents at least the job title extracted from the prompt text. The metadata mapping may include additional fields such as, example, occupation, job hierarchy, qualifications/certification, linguistic classifications, and the like. The metadata mapping may be used to facilitate generation of the résumé by providing a résumé creation system with computer-readable descriptors of the associated content, for example.

Note that FIG. 4 is just one example of a method, and other methods including fewer, additional, or alternative steps are possible consistent with this disclosure.

### Example Processing System

FIG. 5 depicts an example computing environment 500 in which aspects of the present disclosure may be implemented. As shown, the computing environment 500 may include a processing system 502 and a user workstation 512. The processing system 502 may be implemented as a desktop computer, server, mainframe, distributed computer architecture, cloud services, or the like. In certain embodiments, the processing system 502 may operate as a résumé creation system. In other embodiments, the processing system 502 may operate as one component of a résumé creation system.

The user workstation 512, in certain embodiments, may be co-located with, and in communication with the processing system 502 via a local area network (LAN). In other embodiments, the user workstation 512 may be remotely located with respect to the processing system 502, and communication between the user workstation 512 and the processing system 502 may be implemented via the Internet, a wide area network, or the like. The user workstation 512 may be any of a desktop computer system, notebook computer, tablet device, mobile phone device, or the like.

The processing system 502 may include an input/output (I/O) component 504, such as a network interface and associated computer-readable instructions (e.g., firmware) for facilitating communication between the processing system 502 and external devices, such as the user workstation 512, external storage 530, printers, etc. The I/O component 504 is configured to receive prompt text 514 from the user workstation 512, and transmit résumé related data (e.g., résumé content) to the user workstation 512.

The processing system 502 may also include one or more storage devices 506 (also referenced as storage 506), one or more processors, collectively referenced as processor 508.

Processor(s) 508 are generally configured to retrieve and execute instructions stored in one or more storage 506, including local hard disk drives, solid-state storage devices optical storage devices, and the like. Similarly, processor(s) 508 are configured to retrieve and store application data residing in the storage 506. In certain embodiments, processor(s) 508 are included to be representative of a one or more central processing units (CPUs), graphics processing unit (GPUs), tensor processing unit (TPUs), accelerators, field programmable gate arrays (FPGAs), and other processing devices.

The storage 506 may include mass storage devices such as hard disk drives, optical drives, magneto-optical disk drives, solid-state drives, and the like. Additionally, storage 506 may include volatile and non-volatile memory, such as random access memory (RAM), flash memory, and read-only memory (ROM) respectively. In certain embodiments, the memory may be utilized as a RAM disk such that the memory is treated by the processing system as a mass storage device. In FIG. 5, computer-readable instructions 506a-506f are shown as being held in storage 506, generally. However, in practical operation, the computer-readable instructions, and related data may be held in memory, mass storage devices, or a combination of both. For example, the computer-readable instructions may be stored in one or more mass storage devices of storage 506 and during execution of the computer-readable instructions, all or part of the instruction code may be loaded into registers of the volatile memory. Thus, actual execution of some or all of the computer-readable instructions may occur from memory. In other embodiments, the computer-readable instructions are executed directly from the mass storage device, with runtime data being held in volatile memory.

The storage 506 implements computer-readable storage for storing computer-readable instructions configured for implementing, by the processor 508, methods embodying aspects of the present disclosure, such as method 300 shown in FIG. 3, and method 400 shown in FIG. 4, as well as process 200 shown in FIG. 2. In particular, the storage 506 includes prompt receiving instructions 506a, updated prompt creating instructions 506b, AI response receiving instructions 506c, converting instructions 506d, content selecting instructions 506e, and content storing instructions 506f. Additionally, the storage 506 may store data, such as saved prompts 506g. The saved prompts 506g may be embodied in a database. Alternatively, the saved prompts may be held in a delimited text file, where the delimiter may be selected from: colon, space, comma, semicolon, and the like.

The processing system 502 may host web services 510 to provide a user interface (e.g., UI 100 of FIG. 1) having a prompt field (e.g., prompt field 102 of FIG. 1), a content output field (e.g., results field 112 of FIG. 1), and one or more interactive elements (e.g., saved prompts drop-down box 104, run button 108, save prompt button 110, selector element 114, export button 116, and new content button 118 of FIG. 1). The web-based UI may be implemented as one or more webpages 510a. The UI may be displayed to the user on a workstation 512 via a web browser, for example. In certain embodiments, the UI may be implemented as computer-executable code (e.g., application software) residing locally on the workstation 512 and executed by the processor of the workstation 512. The computer-executable code may access the processing system 502 via the Internet, for example, to receive data for populating the various fields and elements of the UI. For example, the computer-executable code may request the saved prompts 506g from the processing system 502 to populate the saved prompts drop-down box 104.

The prompt receiving instructions 506a interact with prompt receiving logic 508a of the processor 508 and the I/O component 504 to perform block 302 shown in FIG. 3, for example, such that the processing system 502 receives a prompt text 514 from the user workstation 512. The prompt text 514 provides parameters for generating the résumé content. The prompt text 514 may include prompt text 514 entered by a user in the prompt field 102 of FIG. 1, or a previously saved prompt text selected from a list of saved prompts 506g displayed in the saved prompts drop-down box 104 of FIG. 1. The prompt text 514, in certain embodiments, may be expanded to include additional instructions to an AI model for instructing the AI model regarding the formatting of the response. For example, the prompt receiving logic 508a may insert instructions directing the AI model to output responses in a JSON format. The instructions may further direct the AI model to output the content in a desired structure or layout.

The updated prompt creating instructions 506b interact with updated prompt creating logic 508b of the processor 508 to perform block 304 of FIG. 3, for example. The updated prompt creating instructions 506b causes the processor 508, via updated prompt creating logic 508b, to create an updated prompt, such as updated prompt 800 shown in FIG. 8. The updated prompt may include: the prompt text 514 submitted by the user by way of the UI, a selected artificial intelligence (AI) model chosen from a set of AI models configured to process the prompt text, AI model parameters configured to control processing of the prompt text by the selected AI model, and response formatting instructions. By having the processing system 502 modify the prompt text 514 received from the user, the user does not need to receive extensive trained on writing AI prompts. Instead, the user need only focus on writing a request, in plain English.

The AI response receiving instructions 506c interact with AI response receiving logic 508c of the processor 508 to perform block 308 of FIG. 3, for example. The AI response receiving instructions 506c causes the processor 508, via AI response receiving logic 508c, to receive a text-based response from the selected AI model based on the prompt text 514.

The converting instructions 506d interact with converting logic 508d of the processor 508 to perform block 308 of FIG. 3, for example. The converting instructions 506d cause the processor 508, via converting logic 508d, to convert the text-based response to one or more résumé contents in a preset format. In certain implementations of aspects of the present disclosure, the response is received from the AI model in a JSON format and converted by known techniques into a text format for insertion into a webpage.

The content selecting instructions 506e interact with content selecting logic 508e of the processor 508 to perform block 310 of FIG. 3, for example. The content selecting instructions 506e cause the processor 508, via content selecting logic 508e, to select a subset of the one or more résumé content as selected résumé content. In certain embodiments, the content selecting instructions cause the processor 508 to receive content selections made by the user by way of actuation of a selector element 114 of FIG. 1.

In certain embodiments, the processing system 502 may include mapping instructions that cause the processor 508 to map one or more of the selected résumé contents to at least the job title by attaching metadata tags the one or more of the selected résumé contents at least the job title extracted from the prompt text. The metadata mapping may include additional fields such as, for example, occupation, job hierarchy, qualifications/certification, linguistic classifications, and the like. The metadata mapping may be used to facilitate generation of a résumé by providing a résumé creation system with computer-readable descriptors of the associated content, for example. The mapping may be performed as an automated process of the processing system 502. Alternatively, some or all of the mapping may be performed manually by the user while reviewing the résumé content by providing values for predefined metadata tags.

The content storing instructions 506f interact with content storing logic 508f of the processor 508 to perform block 312 of FIG. 3, for example. The content storing instructions 506f cause the processor 508, via content storing logic 508f, to store the selected résumé content in a content database in storage 530 for on-demand retrieval and inclusion in a résumé or other employment-related document.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for creating résumé content, comprising: receiving a prompt text submitted by a user by way of a user interface, the prompt text including at least a job title for which to generate the résumé content; creating an updated prompt including: the prompt text, a selected artificial intelligence (AI) model chosen from a set of AI models configured to process the prompt text, AI model parameters configured to control processing of the prompt text by the selected AI model, and response formatting instructions; transmitting the updated prompt to the selected AI model; and receiving a text-based response from the selected AI model based on the prompt text, the text-based response being received in a format corresponding to the response formatting instructions.

Clause 2: The method of Clause 1, further comprising presenting the text-based response as one or more résumé contents to the user for review.

Clause 3: The method of Clause 1 or Clause 2, further comprising: receiving a subset of the one or more résumé contents, selected by the user, as selected résumé contents; and storing the selected résumé contents in a content database for on-demand retrieval and inclusion in a résumé.

Clause 4: The method of any one of Clauses 1-3, further comprising mapping one or more of the selected résumé contents to at least the job title by attaching metadata tags the one or more of the selected résumé contents at least the job title extracted from the prompt text.

Clause 5: The method of any one of Clauses 1-4, further comprising transmitting to the user interface a set of saved prompts from which the prompt text is chosen.

Clause 6: The method of any one of Clauses 1-5, wherein receiving the prompt text further comprises accepting a manually entered prompt text.

Clause 7: A method for generating content for a résumé, comprising: providing a user interface having a prompt field, a content output field, and one or more interactive elements; receiving prompt text at the prompt field, the prompt text being a user request including a job title for which to generate a résumé content; generating an updated prompt including: the prompt text, an artificial intelligence (AI) model selection chosen from a set of AI models configured to process the user request, AI model parameters configured to control the processing of the user request by the AI model selection, and response formatting instructions; and receiving, at a content output field, one or more résumé contents generated by the selected AI model based on the prompt text, the one or more résumé contents being presented in a format corresponding to the response formatting instructions.

Clause 8: The method of Clause 7, further comprising: accepting a user selection of at least one selected résumé content from one or more of the résumé contents; and storing, upon activation of a first interactive element of the one or more interactive elements, the at least one selected résumé content in a résumé content database accessible by a second user interface configured to construct the résumé.

Clause 9: The method of Clause 7 or Clause 8, further comprising mapping the at least one selected résumé content to at least the job title by attaching to metadata of the one or more of the selected résumé contents at least the job title extracted from the prompt text.

Clause 10: The method of any one of Clauses 7-9, further comprising providing a list of saved prompt texts upon activation of a second interactive element of the one or more interactive elements.

Clause 11: The method of any one of Clauses 7-10, further comprising saving the prompt text to the list of saved prompt texts upon activation of a third interactive element of the one or more interactive elements.

Clause 12: The method of any one of Clauses 7-11, wherein the prompt field is configured to selectively receive a selected prompt text from the list of saved prompt texts, or a manually entered prompt text.

Clause 13: A processing system, comprising: a memory comprising computer-executable instructions; and a processor configured to execute the computer-executable instructions and cause the processing system to perform a method in accordance with any one of Clauses 1-12.

Clause 14: A processing system, comprising means for performing a method in accordance with any one of Clauses 1-12.

Clause 15: A non-transitory computer-readable medium storing program code for causing a processing system to perform the steps of any one of Clauses 1-12.

Clause 16: A computer program product embodied on a computer-readable storage medium comprising code for performing a method in accordance with any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for creating résumé content, comprising:
receiving a prompt text submitted by a user by way of a user interface, the prompt text including at least a job title for which to generate the résumé content;
creating an updated prompt including: the prompt text, a selected artificial intelligence (AI) model chosen from a set of AI models configured to process the prompt text, AI model parameters configured to control processing of the prompt text by the selected AI model, and response formatting instructions;
transmitting the updated prompt to the selected AI model; and
receiving a text-based response from the selected AI model based on the prompt text, the text-based response being received in a format corresponding to the response formatting instructions.

2. The method of claim 1, further comprising presenting the text-based response as one or more résumé contents to the user for review.

3. The method of claim 2, further comprising:
receiving a subset of the one or more résumé contents, selected by the user, as selected résumé contents; and
storing the selected résumé contents in a content database for on-demand retrieval and inclusion in a résumé.

4. The method of claim 3, further comprising mapping one or more of the selected résumé contents to at least the job title by attaching metadata tags the one or more of the selected résumé contents at least the job title extracted from the prompt text.

5. The method of claim 1, further comprising transmitting to the user interface a set of saved prompts from which the prompt text is chosen.

6. The method of claim 1, wherein receiving the prompt text further comprises accepting a manually entered prompt text.

7. A method for generating content for a résumé, comprising:
providing a user interface having a prompt field, a content output field, and one or more interactive elements;
receiving prompt text at the prompt field, the prompt text being a user request including a job title for which to generate a résumé content;
generating an updated prompt including: the prompt text, an artificial intelligence (AI) model selection chosen from a set of AI models configured to process the user request, AI model parameters configured to control the processing of the user request by the AI model selection, and response formatting instructions; and
receiving, at a content output field, one or more résumé contents generated by the selected AI model based on the prompt text, the one or more résumé contents being presented in a format corresponding to the response formatting instructions.

8. The method of claim 7, further comprising:
accepting a user selection of at least one selected résumé content from one or more of the résumé contents; and
storing, upon activation of a first interactive element of the one or more interactive elements, the at least one selected résumé content in a résumé content database accessible by a second user interface configured to construct the résumé.

9. The method of claim 8, further comprising mapping the at least one selected résumé content to at least the job title by attaching to metadata of the one or more of the selected résumé contents at least the job title extracted from the prompt text.

10. The method of claim 7, further comprising providing a list of saved prompt texts upon activation of a second interactive element of the one or more interactive elements.

11. The method of claim 10, further comprising saving the prompt text to the list of saved prompt texts upon activation of a third interactive element of the one or more interactive elements.

12. The method of claim 11, wherein the prompt field is configured to selectively receive a selected prompt text from the list of saved prompt texts, or a manually entered prompt text.

13. A processing system, comprising:
a memory comprising computer-executable instructions; and
one or more processors configured to execute computer-executable instructions causing the processing system to:
receive a prompt text submitted by a user by way of a user interface, the prompt text including at least a job title for which to generate a résumé content;
creating an updated prompt including: the prompt text, a selected artificial intelligence (AI) model chosen from a set of AI models configured to process the prompt text, AI model parameters configured to control the processing of the prompt text by the selected AI model, and response formatting instructions;
transmitting the updated prompt to the selected AI model; and
receive a text-based response from the selected AI model based on the prompt text, the text-based response being received in a format corresponding to the response formatting instructions.

14. The processing system of claim 13, wherein the one or more processors are further configured to execute computer-executable instructions causing the processing system to present the text-based response as one or more résumé contents to the user for review.

15. The processing system of claim 14, wherein the one or more processors are further configured to execute computer-executable instructions causing the processing system to:
receive a subset of the one or more résumé contents, selected by the user, as selected résumé contents; and
store the selected résumé contents in a content database for on-demand retrieval and inclusion in a résumé.

16. The processing system of claim 13, wherein the one or more processors are further configured to execute computer-executable instructions causing the processing system to provide a list of previously saved prompt texts upon activation of a first interactive element of the user interface.

17. The processing system of claim 16, wherein the one or more processors are further configured to execute computer-executable instructions causing the processing system to save the prompt text to the list of saved prompt texts upon activation of a second interactive element of the user interface.

18. The processing system of claim 17, wherein a prompt field provided on the user interface is configured to selectively receive a selected prompt text from the list of saved prompt texts, and a manually entered prompt text.

19. The processing system of claim 13, wherein the one or more processors are further configured to execute computer-executable instructions causing the processing system to map one or more of the selected résumé content to at least the job title by attaching to metadata of the one or more of the selected résumé contents at least the job title extracted from the prompt text.
